(19) United States
(12) Patent Application Publication
(10) Pub. No.: US 2020/0084264 A1
(43) Pub. Date: Mar. 12, 2020

(54) SYSTEM AND METHOD FOR SECURE CROSS-DOMAIN FILE TRANSFER

(71) Applicant: Owl Cyber Defense Solutions, LLC, Ridgefield, CT (US)

(72) Inventors: Steven Staubly, Newtown, CT (US); Frederick Clarke, New Milford, CT (US); David Wagenheim, Purdys, NY (US); Michael M. Tsao, Yorktown Heights, NY (US)

(21) Appl. No.: 16/127,439

(22) Filed: Sep. 11, 2018

(51) Int. Cl. H04L 29/08; H04L 29/06; G06F 9/48; G06F 17/30

(52) U.S. Cl. CPC H04L 67/10; H04L 63/04; G06F 9/4881; H04L 67/06; G06F 17/30203; H04L 63/123; G06F 17/30109

(57) ABSTRACT

A system and method for transferring files from a source file server in one network domain to a destination file server in a second separate network domain. A first hardware server computer monitors the source file server for the presence of a new manifest file, downloads the new manifest file, downloads each file identified in the new manifest file; and forwards each downloaded file on an output coupled to an input of a one-way link. The one-way link transfers files only from the input to an output thereof and prevents any signal from passing from the output to the input. A second hardware server is connected to the output of the one-way link and receives each file output from the one-way link and forwards each received file to a file location on the destination file server corresponding to an original file location of that file on the source file server.

### FIELD

This disclosure relates generally to a system and method for secure cross-domain file transfer, and, more particularly, to a system and method for secure cross-domain file transfer which securely and efficiently transfers files from a source file storage system in a first network domain to a destination file storage system in a second separate network domain.

### BACKGROUND

Many organizations have processing and communication environments which include different networks subject to differing levels of security. Such environments may include a highly secure network used to communicate confidential or secret information, and one or more less secure networks that do not process confidential or secret information. Such highly secure networks may have strict limitations on the type of data that can be imported thereto or exported therefrom. In addition, the data within a highly secure network may be subject to differing security requirements.

In some cases, a cross-domain solution (CDS) may be used to transfer data from a highly secure network (the source network) to a less secure network (the destination network), or vice versa. A CDS may be hardware-based in order to ensure that data may only pass from the source network to the destination network and to prevent data or any signal whatsoever from passing from the destination network to the source network. A CDS has an input coupled to the source network and an output coupled to the destination network. The CDS may receive information at the input via a particular protocol, e.g., Transmission Control Protocol (TCP) or User Datagram Protocol (UDP). The CDS may include a filter that filters the files or other data received at the input to prevent any malware or other harmful files from passing to the destination network or to ensure that only approved files received at the CDS input on the source network are passed to the destination network. One drawback of a CDS is that each file or set of data must be sequentially forwarded to the input of the CDS for transfer to the destination network. This can lead to long transfer times and a risk of data overflow on the transmit side of the CDS, due to the need for large nonvolatile storage devices (e.g., hard disks) and the consequent additional time need to write data to and then read from such storage devices.

Accordingly, there is a need for a system and method for secure cross-domain file transfer which overcomes the foregoing problems.

### SUMMARY

In a first aspect, a system is presented for secure cross-domain file transfer from a source file server connected to a first network in a first network domain to a destination file server connected to a second network in a second network domain. The system has a manifest manager application operating on a first hardware server computer in the first network domain and connected to the first network. The manifest manager application is for monitoring a predetermined directory on the source file server to determine when a new manifest file becomes stored therein, for downloading the new manifest file, and for issuing file transfer commands based on contents of the new manifest file. The new manifest file includes a list of files on the source file transfer to be transferred to the destination file server. The system also has a traffic manager application operating on the first hardware server computer for receiving the file transfer commands from the manifest manager application and for allocating one or more send-side worker threads operating on the first hardware server computer for downloading each file identified in the new manifest file from a file location on the source file server identified in the new manifest file. The system further has a send application operating on the first hardware server computer for receiving each file downloaded by the send-side worker threads and for forwarding each received file on an output. The system still further has a one-way link having an input coupled to the first hardware server computer to receive files from the output of the send application and an output. The one-way link is configured to transfer files only from the input to the output and to prevent any signal from passing from the output to the input. The one-way link provides the only communications pathway between the first network domain and the second network domain. The system also has a receive application operating on a second hardware server computer in the second network domain and connected to the second network. The second hardware server computer is coupled to the output of the one-way link. The receive application receives one or more files output from the one-way link and forwards each received file of the received one or more files on an output. Finally, the system has receive-side worker threads operating on the second hardware server computer. Each of the receive-side worker threads is configured to read a file output by the receive application and forward that read file to a file location on the destination file server corresponding to the original file location on the source file server.

In a further embodiment, the first hardware server computer may be connected to the first network via at least two separate network interface cards, with the manifest manager application configured to only use a first of the at least two separate network interface cards. The second hardware server computer may be connected to the second network via a single network interface card or via a plurality of network interface cards. The send application may be a Directory File Transfer System application. The receive application may be a Directory File Transfer System application. Each of the send-side worker threads may store each downloaded file in a nonvolatile memory. The send application may receive files from the send-side worker threads by reading each of the files from the nonvolatile memory. The output of the receive application may be connected to a nonvolatile memory such that each received file of the received one or more files that is forwarded on the output is stored in the nonvolatile memory. Each of the receive-side worker threads may read each file output by the receive application from the nonvolatile memory.

In another further embodiment, he manifest manager application may forward the new manifest file to the send application, the send application may forward the new manifest file on the output, the receive application may receive the new manifest file and store the new manifest file in a memory, and the receive-side worker threads may each compare a calculated hash-value of the file read from the output of the receive application with a corresponding hash-value for such file in the new manifest file and forward that read file to a file location on the destination file server only when the calculated hash-value matches the corresponding hash-value for such file in the new manifest file.

In yet another further embodiment, a send-side logging daemon may generate a syslog message indicating that one or more of the files listed in the new manifest file have been transferred, and the send-side logging daemon may forward the generated syslog message to the source file server. In still another further embodiment, a receive-side logging daemon may generate a syslog message indicating that one or more of the files listed in the new manifest file have been forwarded to the destination file server, and the receive-side logging daemon may forward the generated syslog message to the destination file server.

In a second aspect, a method is presented for secure cross-domain file transfer from a source file server in a first network domain to a destination file server in a second network domain. A predetermined file directory on a source file server in a first network domain is monitored to determine when a new manifest file is stored therein. The new manifest file, which lists files to be transferred from the source file server to a destination file, is retrieved. Each of the files listed in the manifest file is retrieved and each retrieved file is forwarded to an input of a one-way transfer link. Each file received at an output of the one-way transfer link is forwarded to a file storage location on the destination file server corresponding to the associated file storage location on the source file server.

In a further embodiment, the validity of the new manifest file may be verified after retrieving the new manifest file. Also, each of the files listed in the new manifest file may be verified as present in the associated file storage location after retrieving the new manifest file. Further, each of the files listed in the new manifest file may be retrieved without storing any of the retrieved files on a magnetic media-based storage device. Still further, each file received at an output of the one-way transfer link may be forwarded without storing any of the received files on a magnetic media-based storage device. Also, a first hardware server computer in a first network domain may monitor to determine when a new manifest file is stored therein, retrieve the new manifest file, and retrieve each of the files listed in the new manifest file. Finally, a second hardware server in a second network domain may forward each received file to a file storage location on the destination file server.

In another further embodiment, the new manifest file may be forwarded to the input of the one-way transfer link, the new manifest file may be received from the output of the one-way transfer link and stored in a memory, and a calculated hash-value of each received file may be compared with a corresponding hash-value for such file in the new manifest file and that received file may only be forwarded to the file location on the destination file server only when the calculated hash-value matches the corresponding hash-value for such file in the new manifest file.

In yet another further embodiment, a syslog message may be generated indicating that one or more of the files listed in the new manifest file have been transferred, and the generated syslog message may be forwarded to the source file server. In a still another further embodiment, a syslog message may be generated indicating that one or more of the files listed in the new manifest file have been forwarded to the destination file server, and the generated syslog message may be forwarded to the destination file server.

In a third aspect, a system for secure cross-domain file transfer from a source file server connected to a first network in a first network domain to a destination file server connected to a second network in a second network domain is presented. A first hardware server computer is provided in the first network domain and is connected to the first network. The first hardware server computer has an output connected to an input of a one-way link and is configured to monitor a predetermined directory on the source file server to determine when a new manifest file becomes stored therein, to download the new manifest file including a list of files on the source file transfer to be transferred to the destination file server, to download each file identified in the list of files in the new manifest file from a file location on the source file server identified in the new manifest file; and to forward each downloaded file on the output. The one-way link has an input coupled to the first hardware server computer to receive files forwarded on the output of the first hardware server computer and an output. The one-way link is configured to transfer files only from the input to the output and to prevent any signal from passing from the output to the input. The one-way link provides the only communications pathway between the first network domain and the second network domain. A second hardware server computer is provided in the second network domain and is connected to the second network. The second hardware server computer is connected to the output of the one-way link and is configured to receive each file output from the one-way link, and forward each received file to a file location on the destination file server corresponding to the original file location on the source file server.

In a further embodiment, the first hardware server computer may be configured to forward the new manifest file to the input of the one-way transfer link and the second hardware server computer may be configured to receive the new manifest file from the output of the one-way transfer link and store the new manifest file in a memory, and to compare a calculated hash-value of each received file with a corresponding hash-value for such file in the new manifest file and to only forward that received file to the file location on the destination file server only when the calculated hash-value matches the corresponding hash-value for such file in the new manifest file.

In another further embodiment, the first hardware server computer may be configured to generate a syslog message indicating that one or more of the files listed in the new manifest file have been transferred and to forward the generated syslog message to the source file server. In yet another further embodiment, the second hardware server computer may be configured to generate a syslog message indicating that one or more of the files listed in the new manifest file have been forwarded to the destination file server and to forward the generated syslog message to the destination file server.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is a block diagram of a prior art cross-domain solution;

FIG. 2 is a high-level block diagram of a secure cross-domain solution file transfer system according to the present disclosure;

FIG. 3 is a flowchart of the secure cross-domain solution file transfer method according to the present disclosure;

FIG. 4A is diagram of the directory structure of a Network File System for use with the secure cross-domain solution file transfer system of the present disclosure; and FIG. 4B is a diagram of showing an example manifest file in eXtensible Markup Language (XML) form for use with the secure cross-domain solution file transfer system of the present disclosure;

FIG. 5 is a block diagram showing details of the send and receive blocks of the one-way transfer link portion of the secure cross-domain solution file transfer system of the present disclosure; and

FIG. 6 is a detailed block diagram of a further embodiment of the secure cross-domain solution file transfer system according to the present disclosure.

### DETAILED DESCRIPTION

In the present disclosure, like reference numbers refer to like elements throughout the drawings, which illustrate various exemplary embodiments of the present disclosure.

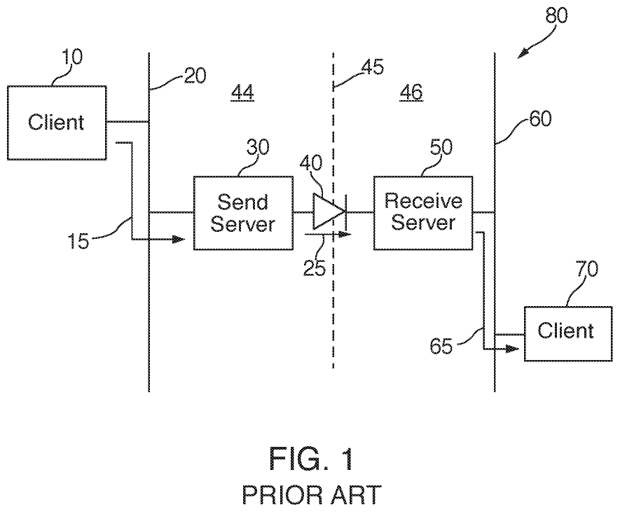

Referring now to the drawings and in particular to FIG. 1, a prior art cross-domain solution system 80 is shown which includes a first client 10 coupled to a first network 20 in a first network domain 44 (the area to the left of dotted line 45). A send server 30 is also coupled to first network 20. The send server 30 is coupled to a receive server 50 via a one-way link 40. The receive server 50 is coupled to a second network 60 in a second network domain 46 (the area to the right of dotted line 45). A second client 70 is also coupled to second network 60. First network 20 is completely isolated from second network 60, except for the one-way transfer path provided by send server 30, one-way link 40, and receive server 50. Typically, the first network 20 has a different security classification than second network 60. To transfer information or files from the first client 10 to the second client 70, first client 10 initiates the transfer by forwarding the information or files to send server 30 (shown by arrow 15 in FIG. 1). This may be done using Transmission Control Protocol/Internet Protocol (TCP/IP) protocol or UDP protocol, as described in detail in U.S. Pat. No. 8,139,581 to Ronald Mraz, et al., the disclosure of which is incorporated herein by reference in its entirety (“the '581 patent”). Send server 30 then forwards the information or files across the one-way link 40 to receive server 50 (shown by arrow 25 in FIG. 1). The one-way link 40 is a hardware-enforced one-way transmission channel which precludes any data (information or files) or signals of any kind from passing in the reverse direction (e.g., from receive server 50 to send server 30). The one-way link 40 may be formed by use of an optical fiber coupled between a send-only interface card coupled to send server 30 and a receive-only interface card coupled to receive server 50. One particular type of hardware-enforced one-way link is shown in more detail in U.S. Pat. No. 8,068,415 B2 to Ronald Mraz, the disclosure of which is incorporated herein by reference in its entirety (“the '415 patent”). Finally, receive server 50 forwards the information or files to the second client 70 (shown by arrow 65 in FIG. 1). This type of CDS is particularly effective in passing data (information or files) across network domains when the volume of data to be passed is not too great and there are no significant time constraints in completing the transfer. This type of CDS typically requires the storage of the data on a magnetic media-based storage device (i.e., hard disk) in the send server 30 when the amount of the data to be transferred exceeds the transfer rate (bandwidth) of the one-way link 40. Since reading from and writing to a magnetic media-based storage device takes more time than reading from or writing to a random access memory, this can add significant time to the transfer process.

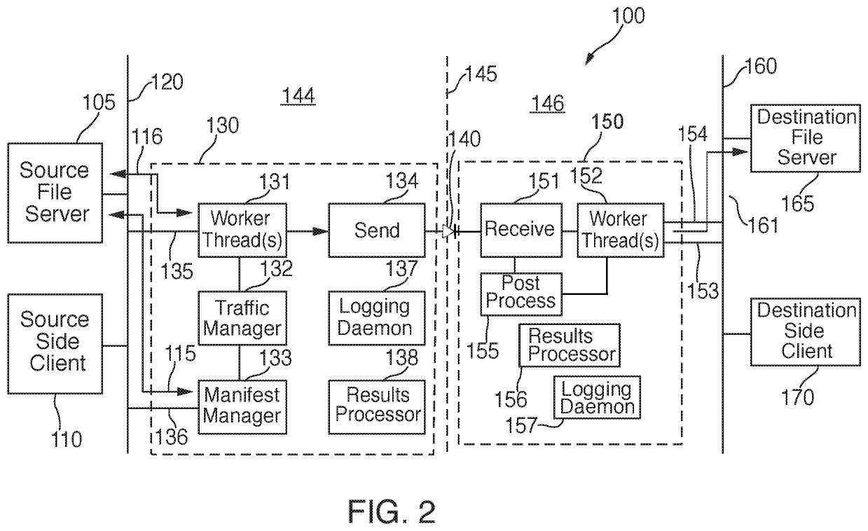

Referring now to FIG. 2, a secure cross-domain file transfer system 100 is shown which includes a first network 120 in a first network domain 144 (the area to the left of dotted line 145) and a completely separate second network 160 in a second network domain 146 (the area to the right of dotted line 145). A source file server 105 and one or more source side clients 110 are connected to first network 120. In addition, a send-side server computer 130 (a hardware-based server) is also coupled to first network 120. A destination file server 165 and one or more destination-side clients 170 are connected to second network 160. In addition, a receive-side server computer 150 (also a hardware-based server) is also coupled to second network 160. Send-side server computer 130 and the receive-side server computer 150 are each hardware server computers. The send-side server computer 130 is coupled to the receive-side server computer 150 only via a one-way link 140. One-way link 140 allows information (e.g., data or files) to pass from an input connected to the send-side server computer 130 to an output connected to the receive-side server computer 150 and prevents any information or signals of any kind from passing from receive-side server computer 150 to the send-side server computer 130. Other than one-way link 140, there are no communication pathways of any sort for information to pass from first network 120 to second network 160, and there are no communication pathways of any sort for information to pass from second network 160 to first network 120.

As described below, the secure cross-domain file transfer system 100 of the present disclosure securely transfers files from source file server 105 in the first network domain 144 to destination file server 165 in the second network domain 146. Typically, the first network domain 144 has a security classification that is different from that of the second network domain 146. The secure cross-domain file transfer system 100 provides a hardware-enforced unidirectional data flow only from the first network 120 to the second network 160 because the send-side server computer 130 is coupled to the receive-side server computer 150 only via the one-way link 140 with no other connections (communication pathways of any sort) between first network 120 and second network 160. One-way link 140 is preferably formed by use of an optical fiber coupled between a send-only interface card installed in send-side server computer 130 and a receive-only interface card installed in receive-side server computer 150, as disclosed in the '415 patent. Owl Cyber Defense Solutions, LLC provides Communication Card Sets that include a pair of specially configured Asynchronous Transfer Mode (ATM) network interface cards (one for “send”, one for “receive”) and a fiber optic cable that are preferably used to form one-way link 140. In higher-bandwidth applications, one-way link 140 may be formed by multiple (two or more) Communication Card Sets (e.g., with two or more send-only interface cards installed in the send-side server computer 130 and two or more corresponding receive-only interface cards installed in receive-side server computer 150, each pair of send-only and receive-only interface cards coupled by a separate fiber optic cable).

Send-side server computer 130 is preferably coupled to first network 120 via a pair of network interface cards 135, 136. Likewise, receive-side server computer 150 is preferably coupled to second network 160 via a pair of network interface cards 153, 154. Each network interface cards 135, 136, 153, 154 is preferably a 10 Gigabit Ethernet (“GbE”) bonded network interface card. In higher-bandwidth applications, additional network interface cards may be used in send-side server computer 130 and receive-side server computer 150 to increase throughput. For lower bandwidth applications, a single network interface card 135 or 136 may be used in send-side server computer 130 and likewise a single network interface card 153 or 154 may be used in receive-side server computer 150.

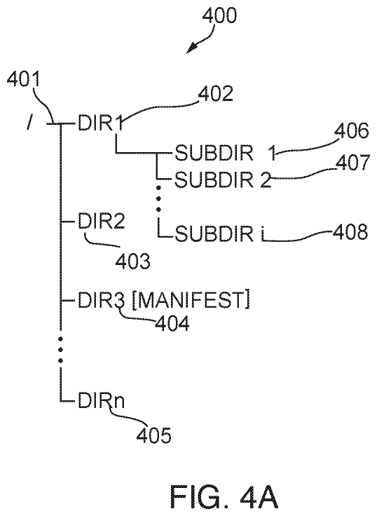

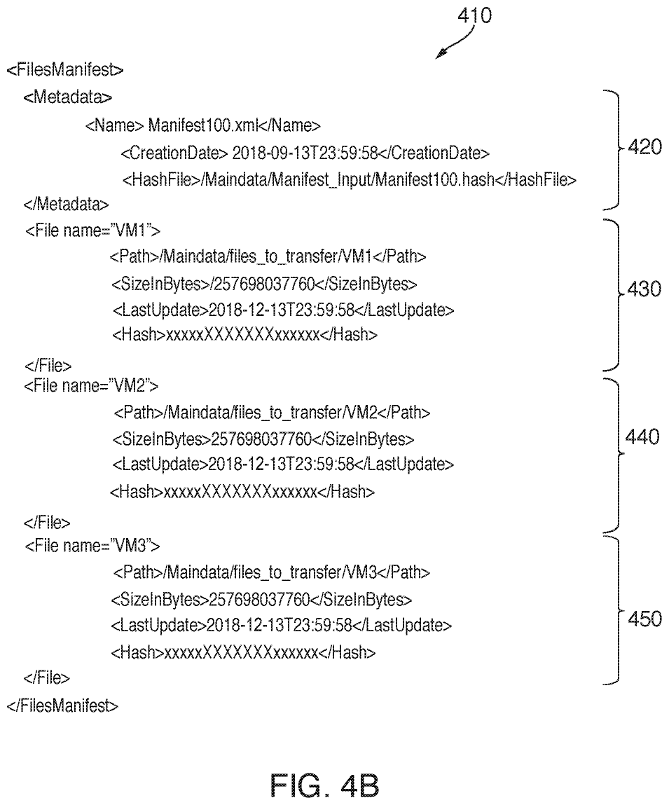

Source file server 105 and destination file server 165 are each preferably a network file server configured to use Network File System (NFS) protocol for communication with clients on the associated network and to provide both read and write access to such clients. In a preferred embodiment, the source file server 105 and destination file server 165 each use NFS version 4 protocol. As shown in FIG. 4A, source file server 105 may be formatted to include a file structure 400, with a root directory 401 and a plurality of top-level directories 402, 403, 404, 405. Each of the top-level directories 402, 403, 404, 405 may include one or more subdirectories, such as subdirectories 406, 407, 408 to top-level directory 402. Source file server 105 is configured to include a directory 405 for holding one or more manifest files and, in one embodiment, the files required to be transferred. In another embodiment, the files for transfer remain in their native directories (i.e., anywhere within the file structure 400) within source file server 105 and the manifest file includes an identification of both the files to be transferred and the source directory for each listed file (as shown in FIG. 4B discussed below). Once a manifest file is copied to the manifest directory on the source file server 105 (i.e., the manifest file is “published”), the files listed in that manifest file cannot be altered in any way until the file copy process is complete to ensure that the hash value for such file does not change.

Send-side server computer 130 includes a manifest manager application 133, a traffic manager application 132, one or more worker threads 131, a send application 134, a logging daemon application 137 and a results processor application 138. As discussed above, send-side server computer 130 also preferably includes two network interface cards 135, 136 for communication with first network 120 and a send-only network interface card (that is part of one-way link 140). Although the worker threads 131 are shown coupled to network interface card 135 and the manifest manager application 133 is shown coupled to network interface card 136 in FIG. 2, in other embodiments when there are more or less than two network interface cards installed in send-side server computer 130, the relative distribution of use of each network interface card (i.e., by information being communicated between worker threads 131 or manifest manager application 133 and first network 120) will vary depending on the particular application.

Manifest manager application 133 manages all aspects of manifest files stored in a reserved predetermined directory on source file server 105. Manifest manager application 133 monitors that predetermined file directory to locate and download each newly-available manifest file (e.g., via pathway 115 shown in FIG. 2). In a preferred embodiment, an associated file is provided for each manifest file which includes a hash value for the manifest file. Manifest manager application 133 first verifies the integrity of each downloaded manifest file by verifying that a hash value calculated for such file matches the hash value provided in the associated file. As one of ordinary skill in the art will readily recognize, other methods may be used to verify the integrity of the manifest file. The manifest manager application 133 also verifies that the manifest file is in a proper format. For example, when the manifest file is provided in eXtensible Markup Language (XML) format, manifest manager application 133 may validate the manifest file using an appropriate software library function, e.g., Apache XERCES, and/or based on a known XML schema. A manifest file 410 in XML format is shown in FIG. 4B which includes metadata information 420 related to manifest file 410 and file information 430, 440, 450 about each of the files to be transferred. The metadata information 420 includes the filename, creation date, and the name of the associated hash file. Each set of file information 430, 440, 450 includes the filename, the absolute path for locating the file, the size of the file (e.g., in bytes), the last time the file was modified, and a hash value (e.g., based on the BLAKE2b hash function) for the file. Manifest manager application 133 accesses source file server 105 to verify that each file listed in the manifest file (e.g., manifest file 410) to verify that each such file exists, has read access, and has not been modified. In an alternative embodiment, the secure cross-domain file transfer system 100 may support manifest files represented as comma-separated values (CSV). In this embodiment, manifest manager application 133 converts each CSV manifest file to XML format using an appropriate conversion tool such as Flat File Extractor.

Validation of the manifest file ensures that the secure cross-domain file transfer system 100 only processes manifest files that are verified and validated, and which conform to the predetermined format. A copy of the manifest file itself may be transferred by secure cross-domain file transfer system 100 by listing the manifest file as one of the files included in the manifest file. This allows for reconciliation of files sent versus files received in the receive-side server computer 150.

Manifest manager application 133 preferably communicates with traffic manager application 132, results processor application 138, and logging daemon application 137 via one-way inter-process communication using message queue. Manifest manager application 133 sends information to traffic manager application 132 about the current manifest file to process. Manifest manager application 133 preferably sends information including status, error, and/or auditing information to the logging daemon application 137 and to the results processor application 138. In a further embodiment, manifest manager application 133 may separately forward each validated manifest file to send application 134 (via a connection not shown in FIG. 2) for transmission across the one-way link 140.

Traffic manager application 132 organizes and schedules the transfer of each of the files listed in the manifest file. Traffic manager application 132 receives information from manifest manager application 133 about the current manifest file to be processed. Preferably, traffic manager application 132 preferably sorts the files listed in the manifest file based on size and allocates one or more worker threads 131 for validating and copying an assigned associated file among the files listed in the manifest file. The allocation of worker threads 131 to files is preferably done based on file size, in order from largest file to smallest.

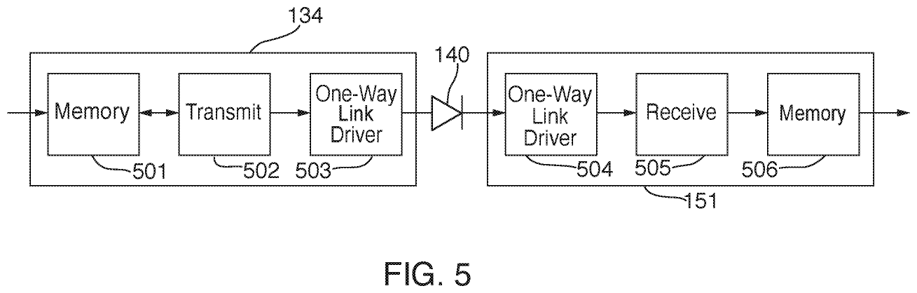

Each worker thread 131 reads the assigned file from the subdirectory identified in the manifest file (or alternatively from the manifest directory) on source file server 105 (via pathway 116 shown in FIG. 2), validates the file based on expected hash value (using the hash value from the manifest file), and copies the read and verified file to send application 134. Send application 134, in turn, forwards each read and verified file on an output thereof which is connected to an input of one-way link 140. As discussed below with respect to FIG. 5, send application 134 is preferably one or multiple instances of the Directory File Transfer System (DFTS) (send side) provided by Owl Cyber Defense Solutions, LLC. In some instances, depending on the particular file size, the number of files to be transmitted, and the read performance of the source file server 105, traffic manager application 132 may allocate more than one worker thread 131 for each file. Traffic manager application 132 communicates with the results processor application 138 to provide status information for each file processed by a worker thread 131. In some cases, worker threads 131 may also communicate directly with the results processor application 138 to provide certain status information. Traffic manager application 132 also communicates with logging daemon application 137 to provide error and/or auditing information.

Results processor application 138 receives messages containing status information from the traffic manager application 132 and worker threads 131. The status information from traffic manager application 132 may include information about the start and completion of processing a manifest file. Results processor application 138 also aggregates the status information received from each of the worker threads 131 and creates a complete report specific to the manifest file currently being processed. This report is preferably in XML format. Results processor application 138 may additionally provide a tool, e.g., eXtensible Stylesheet Language Transformations (XLST), for converting the report from XML format to a more human-readable format. Results processor application 138 also sends a status message to manifest manager application 133 after the completion of processing all the files listed in a particular manifest file and error and auditing information to the logging daemon application 137 for logging.

The logging daemon application 137 receives log and auditing information from manifest manager application 133, traffic manager application 132, results processor application 138 and Post Process components. The logging daemon application 137 enters the received log and auditing information into an associated log file. In a further embodiment, logging daemon application 137 generates one or more syslog messages, subsequently forwarded to source file server 105, indicating that the transmission of the files listed on a particular manifest has been completed. Such syslog messages may be generated separately for each file or only after all the files in a particular manifest have been transferred. Source file server 105 may use such syslog messages to signal that such files are again available for use (i.e., such files may then be altered, etc.).

Receive-side server computer 150 includes a receive application 151, a post process application 155, one or more worker threads 152, a results processor application 156, and a logging daemon application 157. As discussed above, receive-side server computer 150 also preferably includes two network interface cards 153, 154 for communication with second network 160 and a receive-only network interface card (that is part of one-way link 140). The worker threads 152 are shown coupled to the two network interface cards 153 in FIG. 2. In other embodiments when there are more or less than two network interface cards installed in receive-side server computer 150, the relative distribution of use of each network interface card by the worker threads 152 will vary depending on the particular application.

Receive application 151 is preferably one or multiple instances of the Directory File Transfer System (DFTS) Data Transfer System (receive side) provided by Owl Cyber Defense Solutions, LLC. Receive application 151 receives files on an input thereof that is connected to an output of one-way link 140 and copies such files to a temporary memory (preferably a volatile memory such as DRAM to increase throughput). Post process application 155 either monitors a directory coupled to receive application 151 to identify each newly-received file or receives information from receive application 151 indicating the receipt of a newly-received file. Post process application 155 then allocates one or more worker threads 152 to copy the newly-received file to the appropriate final location (e.g., based on file directory information included in the filename) on the destination file server 165 (e.g., via pathway 161 shown in FIG. 2). Post process application 155 also provides status information about transferred files to results processor application 156 and to logging daemon application 157. In a further embodiment, post process application 155 also reads the transferred validated manifest file and forwards the hash value of each newly-received file to the associated work thread 152 when allocating that worker thread 152 to perform the file copy process. The allocated worker thread 152 validates the assigned file by comparing a calculated hash value of the newly-received file with the hash value from the manifest file, and only copies the newly-received file to the appropriate final location on the destination file server 165 when the hash values match. This provides a redundant check that the file copied to the final location on destination file server 165 has not been spoofed after creation of the manifest file.

Results processor application 156 receives messages containing status information from the post process application 155 and worker threads 152. Results processor application 156 aggregates the status information received from each of the worker threads 152 and creates a complete report specific to the manifest file currently being processed. This report is preferably in XML format. Results processor application 156 may additionally provide a tool, e.g., eXtensible Stylesheet Language Transformations (XLST), for converting the report from XML format to a more human-readable format. Results processor application 156 also sends error and auditing information to the logging daemon application 157 for logging. Results processor application 156 also copies each report generated to the final destination file storage server.

Logging daemon application 157 receives log and auditing information from the results processor application 138 and the post process application 155. Logging daemon application 157 enters the received log and auditing information into an associated log file. In a further embodiment, logging daemon application 157 generates one or more syslog messages, subsequently forwarded to destination file server 165, indicating that files listed on a particular manifest have been stored on destination file server 165. Such syslog messages may be generated separately for each file or only after all the files in a particular manifest have been transferred. Destination file server 165 may use such syslog messages to signal to an end user that such files are now available for use.

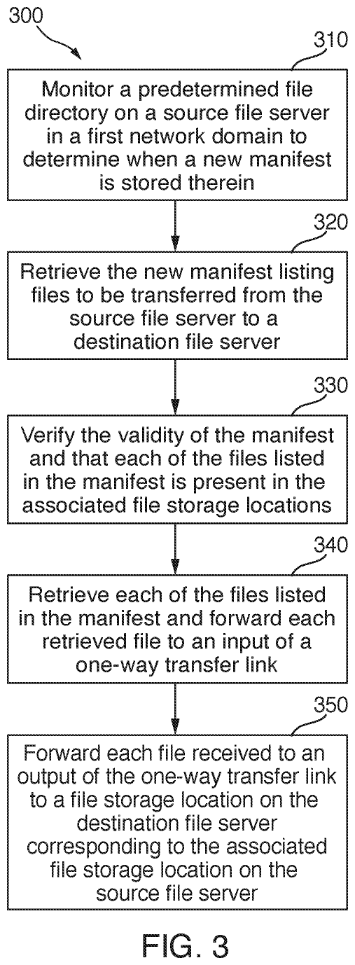

Referring now to FIG. 3, a flowchart 300 is shown describing the operation of the secure cross-domain file transfer system 100 of FIG. 2. First, at step 310, a predetermined file directory on a source file server in a first network domain is monitored to determine when a new manifest is stored therein. Next, at step 320, the new manifest that includes a list of files to be transferred from the source file server to a destination file server is retrieved. Further, at step 330, the validity of the manifest is verified. In addition, it is also verified at step 330 that each of the files listed in the manifest is present in the associated file storage location. Still further, at step 340, each of the files listed in the manifest retrieved and forwarded to an input of a one-way transfer link without storing any of the files on a magnetic media-based storage device. Finally, at step 350, each file received at an output of the one-way transfer link is forwarded to a file storage location on the destination file server corresponding to the associated file storage location on the source file server without storing any of the received files on a magnetic media-based storage device.

Referring now to FIG. 5, a further breakdown of the send application 134 and the receive application 151 of FIG. 2 is shown. In particular, send application 134 includes a memory 501, a transmit application 502, and a one-way link driver 503. In addition, receive application 151 includes a one-way link driver 504, a receive application 505, and a memory 506. The memories 501, 506 may form a RAM disk in order to make the files stored therein more easily accessible and are preferably volatile (e.g., DRAM) to provide a much faster throughput than would any type of non-volatile memory. In operation, files to be transferred across one-way link 140 are first copied to memory 501. Transmit application 502 monitors the memory 501 and forwards any file newly stored in memory 501 to the one-way link driver 503 which, in turn, causes such file to be transmitted across one-way link 140. One-way link driver 504 receives files from the one-way link 140 and forwards any received file to receive application 505, which stores any received file in memory 506. As discussed above with respect to FIG. 2, once a received file is stored in memory 506, post process application 155 assigns a worker thread 152 to copy such file to the appropriate location on destination file server 165 (via one or more of the network interface cards 153, 154).

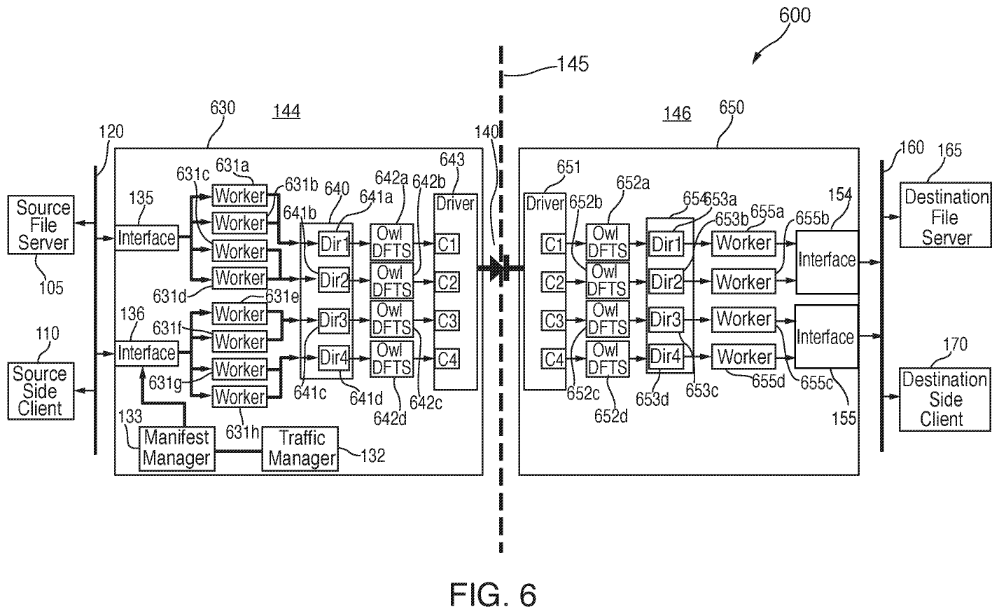

Referring now to FIG. 6, a further embodiment of a secure cross-domain file transfer system 600 is shown which uses four operating instances of the Owl Directory File Transfer System (DFTS) Data Transfer System to perform the functionality of the send application 134 and receive application 151 of the system 100 shown in FIG. 2. In particular, the secure cross-domain file transfer system 600 includes a send-side server computer 630 which includes, preferably, up to 8 operating instances of worker threads 631a to 631h. As in the embodiment of FIG. 2, each of the worker threads 631a to 631h is assigned by traffic manager application 132 (based on information from manifest manager application 133) to copy a particular file from a directory on source file server 105 to an associated directory among directories 641a to 641d on memory 640. In the embodiment shown in FIG. 6, worker threads 631a and 631b are associated with directory 641a, worker threads 631c and 631d are associated with directory 641b, worker threads 631e and 631f are associated with directory 641c, and worker threads 631g and 631h are associated with directory 641d. Other arrangements may be provided with respect to the relationship between worker threads 631a to 631h and the directories 641a to 641d. The connections between traffic manager application 132 and worker threads 631a to 631h are not shown in FIG. 6 for clarity. Memory 640 is a volatile memory preferably formatted as a ram disk. Each directory 641a to 641d is associated with a separate operating instance of the Owl DFTS data transfer system application (i.e., one of DFTS application 642a to 642d). Each of the DFTS application 642a to 642d continually monitors the associated directory 641a to 641d and forwards any newly written files therein to a one-way link driver 643. The one-way link driver 643 forwards any received files across one-way link 140.

The secure cross-domain file transfer system 600 also includes a receive-side server computer 650 which includes, preferably, up to four operating instances of worker threads 655a to 655d. Receive-side server computer 650 includes a one-way link driver 651 which receives files provided to the one-way link 140 by one-way link driver 643, and then forwards such files to one of the four operating instances of the Owl DFTS data transfer system application 652a to 652d. Each operating instance of the Owl DFTS data transfer system application 652a to 652d forwards a file received via the one-way link driver 651 to an associated directory 653a to 653d on a memory 654. Memory 654 is a volatile memory preferably formatted as a ram disk. The respective worker threads 655a to 655d are assigned to an associated one of the directories 653a to 653d and operate to forward a file newly written into the associated directory among directories 653a to 653d to a particular directory on the destination file server 165 (via second network 160 and an associated network interface card 153 or 154). The system disclosed herein speeds transfer speeds by eliminating bottlenecks in transfer that occur when using slower memories based on magnetic-media or solid-state drive media. In addition, because the files transferred are read from their native directory, the storage requirements at source file server 105 are great reduced because there is no need for any temporary staging directory. Finally, the hash value validation of each file ensures that none of the files transferred were spoofed between the time of publication of each manifest file and the actual time for file transfer.

Although the present invention has been particularly shown and described with reference to the preferred embodiments and various aspects thereof, it will be appreciated by those of ordinary skill in the art that various changes and modifications may be made without departing from the spirit and scope of the invention. It is intended that the appended claims be interpreted as including the embodiments described herein, the alternatives mentioned above, and all equivalents thereto.

What is claimed is:

1. A system for secure cross-domain file transfer from a source file server connected to a first network in a first network domain to a destination file server connected to a second network in a second network domain, comprising:
a manifest manager application operating on a first hardware server computer in the first network domain and connected to the first network, the manifest manager application for monitoring a predetermined directory on the source file server to determine when a new manifest file becomes stored therein, for downloading the new manifest file, and for issuing file transfer commands based on contents of the new manifest file, the new manifest file including a list of files on the source file server to be transferred to the destination file server;
a traffic manager application operating on the first hardware server computer for receiving the file transfer commands from the manifest manager application and for allocating one or more send-side worker threads operating on the first hardware server computer for downloading each file identified in the new manifest file from a file location on the source file server identified in the new manifest file;
a send application operating on the first hardware server computer for receiving each file downloaded by the send-side worker threads and for forwarding each received file on an output;
a one-way link having an input coupled to the first hardware server computer to receive files from the output of the send application and an output, the one-way link configured to transfer files only from the input to the output and to prevent any signal from passing from the output to the input, the one-way link providing the only communications pathway between the first network domain and the second network domain;
a receive application operating on a second hardware server computer in the second network domain and connected to the second network, the second hardware server computer coupled to the output of the one-way link, the receive application receiving one or more files output from the one-way link and forwarding each received file of the received one or more files on an output; and
receive-side worker threads operating on the second hardware server computer, each of the receive-side worker threads configured to read a file output by the receive application and forward that read file to a file location on the destination file server corresponding to the original file location on the source file server.

2. The system for secure cross-domain file transfer of claim 1, wherein the first hardware server computer is connected to the first network via at least two separate network interface cards, with the manifest manager application configured to only use a first of the at least two separate network interface cards.

3. The system for secure cross-domain file transfer of claim 1, wherein the second hardware server computer is connected to the second network via a single network interface card.

4. The system for secure cross-domain file transfer of claim 1, wherein the second hardware server computer is connected to the second network via a plurality of network interface cards.

5. The system for secure cross-domain file transfer of claim 1, wherein the send application is a Directory File Transfer System application.

6. The system for secure cross-domain file transfer of claim 1, wherein the receive application is a Directory File Transfer System application.

7. The system for secure cross-domain file transfer of claim 1, wherein each of the send-side worker threads stores each downloaded file in a nonvolatile memory.

8. The system for secure cross-domain file transfer of claim 7, wherein the send application receives files from the send-side worker threads by reading each of the files from the nonvolatile memory.

9. The system for secure cross-domain file transfer of claim 1, wherein the output of the receive application is connected to a nonvolatile memory such that each received file of the received one or more files that is forwarded on the output is stored in the nonvolatile memory.

10. The system for secure cross-domain file transfer of claim 9, wherein each of the receive-side worker threads reads each file output by the receive application from the nonvolatile memory.

11. The system for secure cross-domain file transfer of claim 1, wherein the manifest manager application forwards the new manifest file to the send application, wherein the send application forwards the new manifest file on the output, wherein the receive application receives the new manifest file and stores the new manifest file in a memory, and wherein the receive-side worker threads each compares a calculated hash-value of the file read from the output of the receive application with a corresponding hash-value for such file in the new manifest file and forwards that read file to a file location on the destination file server only when the calculated hash-value matches the corresponding hash-value for such file in the new manifest file.

12. The system for secure cross-domain file transfer of claim 1, further comprising a send-side logging daemon for generating a syslog message indicating that one or more of the files listed in the new manifest file have been transferred.

13. The system for secure cross-domain file transfer of claim 12, wherein the send-side logging daemon forwards the generated syslog message to the source file server.

14. The system for secure cross-domain file transfer of claim 1, further comprising a receive-side logging daemon for generating a syslog message indicating that one or more of the files listed in the new manifest file have been forwarded to the destination file server.

15. The system for secure cross-domain file transfer of claim 14, wherein the receive-side logging daemon forwards the generated syslog message to the destination file server.

16. A method for secure cross-domain file transfer from a source file server in a first network domain to a destination file server in a second network domain, comprising the steps of:
monitoring a predetermined file directory on a source file server in a first network domain to determine when a new manifest file is stored therein;
retrieving the new manifest file that includes a list of files to be transferred from the source file server to a destination file;
retrieving each of the files listed in the new manifest file and forwarding each retrieved file to an input of a one-way transfer link; and
forwarding each file received at an output of the one-way transfer link to a file storage location on the destination file server corresponding to an associated file storage location on the source file server.

17. The method of claim 16, further comprising the step of verifying that the new manifest file is valid after retrieving the new manifest file.

18. The method of claim 16, further comprising the step of verifying that each of the files listed in the new manifest file is present in an associated file storage location after retrieving the new manifest file.

19. The method of claim 16, wherein the step of retrieving each of the files listed in the new manifest file is performed without storing any of the retrieved files on a magnetic media-based storage device.

20. The method of claim 16, wherein the step of forwarding each file received at an output of the one-way transfer link is performed without storing any of the received files on a magnetic media-based storage device.

21. The method of claim 16, wherein the monitoring step is performed by a first hardware server in a first network domain.

22. The method of claim 16, wherein the retrieving the new manifest file step is performed by a first hardware server in a first network domain.

23. The method of claim 16, wherein the retrieving each of the files listed in the manifest file step is performed by a first hardware server computer in a first network domain.

24. The method of claim 16, wherein the forwarding step is performed by a second hardware server in a second network domain.

25. The method of claim 16, further comprising the steps of:
forwarding the new manifest file to the input of the one-way transfer link;
receiving the new manifest file from the output of the one-way transfer link and storing the new manifest file in a memory; and
comparing a calculated hash-value of each received file with a corresponding hash-value for such file in the new manifest file and only forwarding that received file to the file location on the destination file server only when the calculated hash-value matches the corresponding hash-value for such file in the new manifest file.

26. The method of claim 16, further comprising the step of generating a syslog message indicating that one or more of the files listed in the new manifest file have been transferred.

27. The method of claim 26, further comprising the step of forwarding the generated syslog message to the source file server.

28. The method of claim 16, further comprising the step of generating a syslog message indicating that one or more of the files listed in the new manifest file have been forwarded to the destination file server.

29. The method of claim 28, further comprising the step of forwarding the generated syslog message to the destination file server.

30. A system for secure cross-domain file transfer from a source file server connected to a first network in a first network domain to a destination file server connected to a second network in a second network domain, comprising:
a first hardware server computer in the first network domain and connected to the first network, the first hardware server computer having an output connected to an input of a one-way link and configured to:
monitor a predetermined directory on the source file server to determine when a new manifest file becomes stored therein,
download the new manifest file including a list of files on the source file server to be transferred to the destination file server,
download each file identified in the list of files in the new manifest file from a file location on the source file server identified in the new manifest file; and
forward each downloaded file on the output;
the one-way link having the input coupled to the first hardware server computer to receive files forwarded on the output of the first hardware server computer and an output, the one-way link configured to transfer files only from the input to the output and to prevent any signal from passing from the output to the input, the one-way link providing the only communications pathway between the first network domain and the second network domain; and
a second hardware server computer in the second network domain and connected to the second network, the second hardware server computer connected to the output of the one-way link and configured to:
receive each file output from the one-way link, and
forward each received file to a file location on the destination file server corresponding to the original file location on the source file server.

31. The system of claim 30, wherein the first hardware server computer is configured to forward the new manifest file to the input of the one-way transfer link; and
the second hardware server computer is configured to:
receive the new manifest file from the output of the one-way transfer link and store the new manifest file in a memory; and
compare a calculated hash-value of each received file with a corresponding hash-value for such file in the new manifest file and only forward that received file to the file location on the destination file server only when the calculated hash-value matches the corresponding hash-value for such file in the new manifest file.

32. The system of claim 30, wherein the first hardware server computer is configured to generate a syslog message indicating that one or more of the files listed in the new manifest file have been transferred.

33. The system of claim 32, wherein the first hardware server computer is configured to forward the generated syslog message to the source file server.

34. The system of claim 30, wherein the second hardware server computer is configured to generate a syslog message indicating that one or more of the files listed in the new manifest file have been forwarded to the destination file server.

35. The system of claim 34, wherein the second hardware server computer is configured to forward the generated syslog message to the destination file server.
